(19) United States
(12) Patent Application Publication
(10) Pub. No.: US 2007/0005741 A1
(43) Pub. Date: Jan. 4, 2007

(54) Facilitating radio communications in a mobile device

(75) Inventors: Daniel Hwang, Renton, WA (US); Gary W. Hall, Redmond, WA (US); Yaroslav Goncharov, Redmond, WA (US); Jayant Ravalia, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/172,440

(22) Filed: Jun. 30, 2005

(51) Int. Cl. G06F 15/173

(52) U.S. Cl. 709/223

(57) ABSTRACT

A system and method for managing radio communication availability in a mobile device is provided. A mobile device includes a communication management component that interacts with radio and network layer components on the mobile device to keep communications available. The interaction can correspond to the transmittal of instructions to the radio and network layer components, which can include instructions to send communications via a communication network.

### BACKGROUND

Generally described, mobile devices, such as mobile telephones and hand-held devices, can utilize communication networks, such as the Internet, to exchange data with other mobile devices and/or computer devices. In a typical embodiment, a mobile device can utilize a wireless communication network, and various network protocols, to transmit and receive data from a variety of network sources. In such an embodiment, a mobile device can maintain continuous, or semi-continuous, wireless connections to allow a user with a mobile device to receive and transmit information. As the computing device processing resources and wireless network communication bandwidth continue to increase, the use of wireless enabled mobile devices to receive/transmit information has substantially increased.

In one common application, mobile devices with wireless communication capabilities can be used to periodically connect to a communication network and retrieve information, such as electronic mail. For example, a mobile device can be configured to periodically connect to a network-based electronic mail store and retrieve new electronic mails or notifications related to new electronic mails. For application in which information retrieval is repeated, two factors can affect the performance and reliability of the information availability. In one aspect, a mobile device will be subject to the availability and quality of the wireless network connection. In another aspect, the mobile device will be subject to the interoperation of the device transmitter/receiver and network functionality with the operating system/software application directing the data retrieval.

There are a number of solutions that correlate the performance and response of a mobile device to various detected network and device conditions. Regardless of the availability and quality of a wireless connection to a communication network, these solutions do not address deficiencies associated with interoperability between software application/operating environment components and hardware-based radio communication and networking components. In one aspect, the radio communication and networking components may include specific optimizations/configurations that cause the radio communication and networking components to become unavailable, such as for saving power. Because a common software application and/or operating environment may be running of any number of hardware platforms, software providers must be required to provide and support customized software application for a variety of hardware platforms or accept application errors associated with interoperability.

### SUMMARY

A system and method for managing radio communication availability in a mobile device is provided. A mobile device includes a communication management component that interacts with radio and network layer components on the mobile device to keep communications available. The interaction can correspond to the transmittal of instructions to the radio and network layer components, which can include instructions to send communications via a communication network.

In accordance with an aspect of the present invention, a method for managing radio frequency communications in a mobile device is provided. The mobile device can include a communication management component that transmits a first data request using an application-level communication protocol. The application-level communication protocol can correspond to an HTTP information request. Prior to receiving a response corresponding to the first data request, the communication management component transmits at least one data packet using a network-level communication protocol prior. The data packet transmission can correspond to a TCP Connect data packet. If a time threshold has been exceeded prior to receiving a response corresponding to the first data request, the communication management component transmits a second data request using the application-level communication protocol. Finally, prior to receiving a response corresponding to the second data request, the communications management component transmits at least one data packet using the network-level communication protocol.

In accordance with another aspect of the present invention, a computer-readable medium having computer-executable components for managing communications in a radio device is provided. The computer-executable components include a network layer and radio layer communication component for transmitting and receiving data. Additionally, the computer-executable components include a communications management component for transmitting an instruction to the network layer and radio layer communication component to elicit an action. The instruction can correspond to an instruction to transmit a communication via various communication protocols. The instruction can also correspond to an instruction to initiate a voice call and/or to toggle a power mode.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a mobile device communication system including a mobile device in communication with a number of network based applications via a communication network in accordance with an aspect of the present invention;

FIG. 2 is a block diagram of the mobile device communication system of FIG. 1 illustrating the interaction between various components of the mobile device components to maintain available communication channels in accordance with an aspect of the present invention;

FIG. 3 is a flow diagram illustrative of a radio communication priming routine implemented by a mobile device in accordance with an aspect of the present invention;

FIG. 4 is a communication diagram illustrative of a first set of communications transmitted from a mobile device in accordance with an aspect of the present invention;

FIG. 5 is a communication diagram illustrative of a first and second set communications transmitted from a mobile device in accordance with an aspect of the present invention; and

FIG. 6 is a communication diagram illustrative of a first, second and third set of communications transmitted from a mobile device in accordance with an aspect of the present invention.

### DETAILED DESCRIPTION

Generally described, the present invention relates to a system and method for managing radio communications in mobile devices. More specifically, the present invention relates to a system and method for managing radio communication availability in mobiles devices utilizing interactions between software/operating system components and hardware-based radio and networking components. The interactions can include the transmission of repeated application-level communications and repeated network-level communications by the mobile device. Although the present invention will be described with regard to an illustrative communications environment, illustrative communication protocols and example interactions between mobile device components, one skilled in the relevant art will appreciated that the disclosed embodiments should not be construed as limiting.

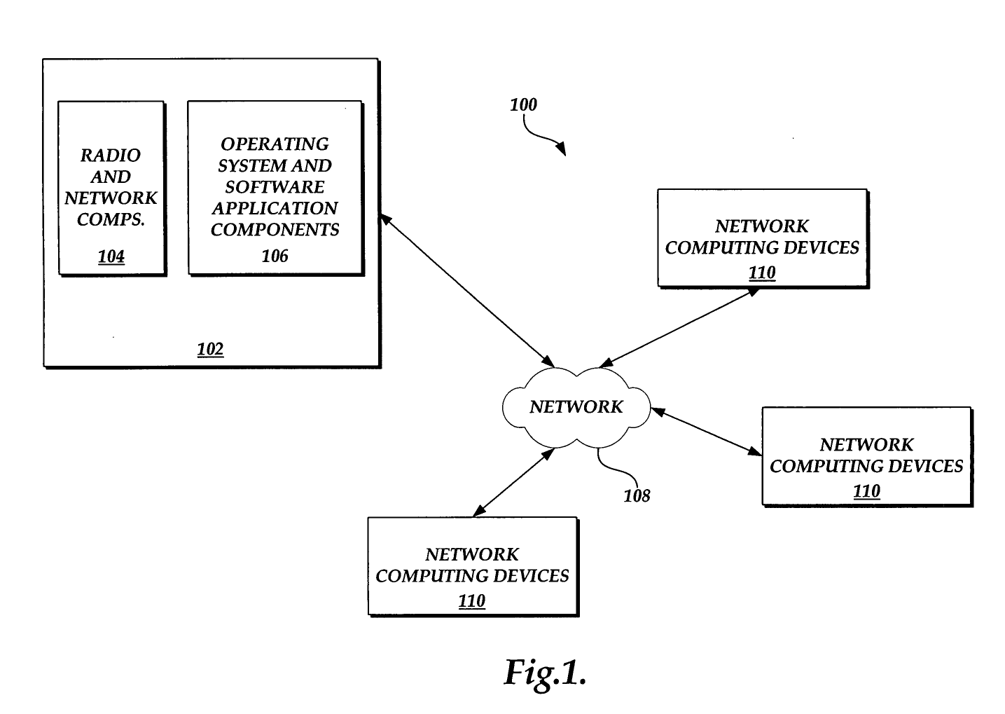

FIG. 1 is a block diagram illustrative of a mobile device communication system 100 formed in accordance with an aspect of the present invention. The mobile device communication system 100 includes one or more mobile devices 102. In an illustrative embodiment, the mobile devices 102 can include a variety of hardware devices such as mobile computing devices, portable communication devices, mobile telephones and the like. The mobile device 102 includes a radio and network layer components 104 for facilitating wireless communication. The mobile device 102 also includes an operating system and software components 106 for maintaining radio communication availability through the radio and network layer components 104, as will be described in greater detail below.

With continued reference to FIG. 1, the one or more mobile devices 102 are in wireless communication to a communication network 108, such as the Internet. In turn, the mobile device 102 can connect to one or more network computing devices 110 via the communication network 108. In an illustrative embodiment, the network computing devices 110 can provide information to the mobile device 102 upon request or in response to criteria. The network computing devices 110 can include electronic mail interfaces, Web servers, gaming servers, and other data providers. One skilled in the relevant art will appreciate that the mobile device communication system 100 can also include additional components and/or service providers, such as a mobile device service operator, that may be required to connect mobile devices to the communication network 108. Additionally, one skilled in the relevant art will appreciate that the radio and network layer components 104 and the operating system and software application layer components 106 of the mobile device 102 can include additional software and hardware components that facilitate the operation of the device and its communications with the communication network 108.

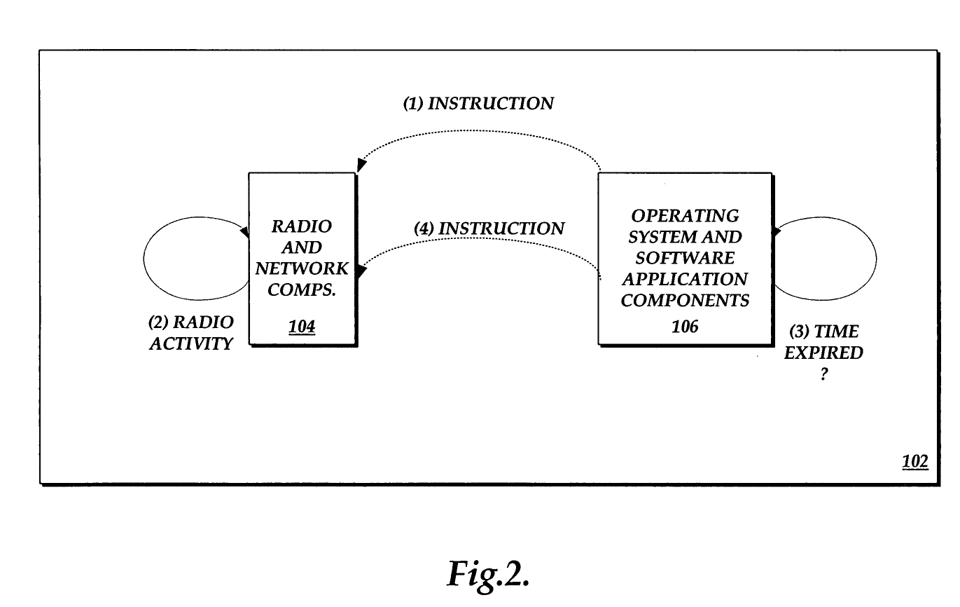

With reference now to FIG. 2, the interaction between the radio and network layer components 104 and operating system and software application layer components 106 to maintain mobile device 102 communication availability will be described. In an illustrative embodiment, the mobile device 102 may include one or more software application or software components that manage the frequency of requests for information from the communication network 108 based on perceived network and/or mobile device conditions. For example, the mobile device 102 may increase the frequency of requests for information during perceived poor communication conditions (e.g., bad reception). Similarly, the mobile device 102 may decrease the frequency of requests for information during perceived good communication conditions. Similarly, the mobile device 102 may implement additional algorithms to better adjust to changing network or device conditions.

In conjunction with any additional communication management components, such as the components described above, the operating system and software application layer components 106 can include an additional communication management component that interacts with the radio and network layer components 104 to maintain the availability of the radio transmission capabilities of the mobile device 102. More specifically, in an illustrative embodiment, the communication management component can transmit one or more instructions via standard application protocol interfaces (“APIs”) that require some type of activity/interaction by at least a portion of the radio and network layer components. In one embodiment, the instruction can correspond to an instruction for the radio and network components to power on, or otherwise, reset. In another embodiment, the instruction can correspond to an instruction for the mobile device 102 to initiate a voice communication, e.g., a telephone call, to a designated telephone number. In still a further embodiment, the instruction may correspond to an instruction for the mobile device 102 to initiate a data communication to a designated recipient via the communication network 108. In one embodiment, the communication management component can transmits a repeated series of instructions to the radio and network layer components 104. Additionally, the communication management component can transmit a combination of one or more instructions to the radio and network layer components 104.

With reference to the embodiment in which the communication management component transmits instruction related to data transmissions, an illustrative embodiment will be described. In accordance with this embodiment, the communication management component transmits an instruction for the radio and network layer components 104 to transmit a first communication request. In an illustrative embodiment, the first communication request corresponds to an application-level communication protocol, such as a hypertext transfer protocol (“HTTP”) GET request. If the first communication request fails to get a proper response, the communication management component begins transmits an instruction to the radio and network layer components 104 to transmit a network-level communication. In an illustrative embodiment, the network-level communications corresponds to a transfer control protocol (“TCP”) connect or DNS communications. The radio and network layer components 104 may continue retrying the network-level communication. Upon expiration of a retry threshold, the communication management component instructs the radio and network layer components 104 to transmit a second communication request via the application-level communication protocol. If the second communication request fails to get a proper response, the communications management components instructs the radio and network layer components 104 to transmit another network layer communication. If the application-layer and network layer communications continue to fail to generate a response, the communication management component will stop trying to establish communication.

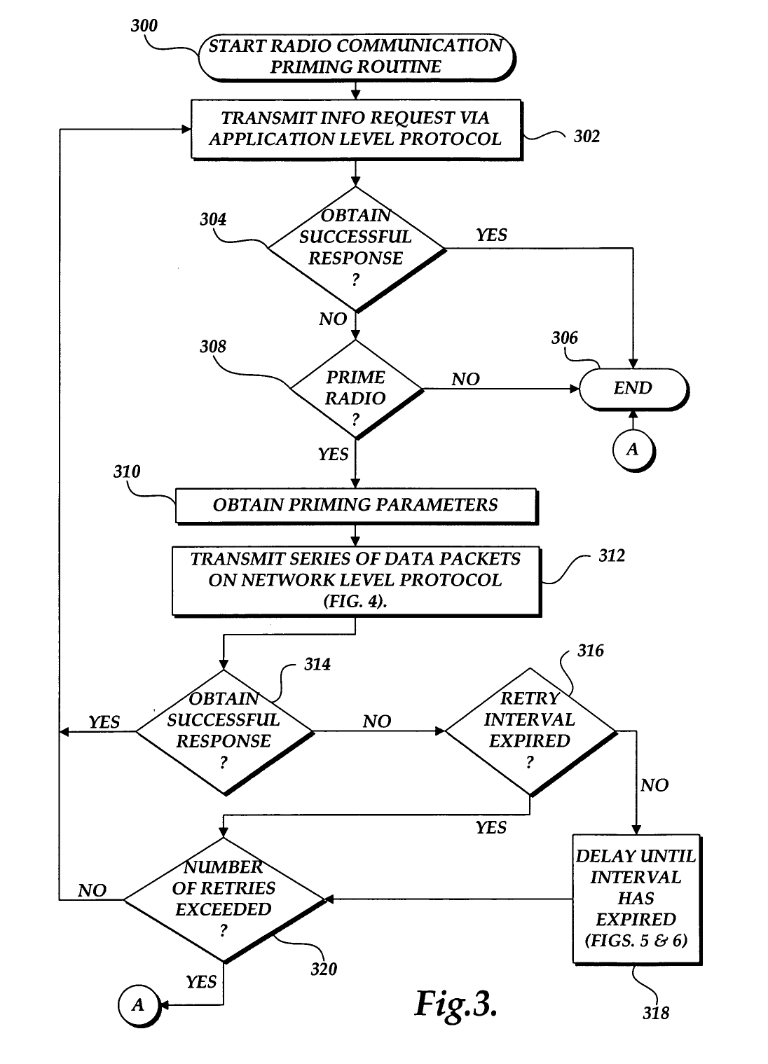

FIG. 3 is a flow diagram illustrative of a radio communication priming routine 300 implemented by a mobile device 102 in accordance with an aspect of the present invention. At block 302, the communication management component instructs the radio and network layer components 104 to transmit a request for information utilizing an application-level communication protocol. As described above, the request for information can correspond to an HTTP GET request. For example, the mobile device 102 can utilize the HTTP request to request for notification of any incoming electronic mails. At decision block 304, a test is conducted to determine whether a successful response has been received. If a successful response has been received, the mobile device 102 communication availability will not be concern until the next request for information. Accordingly, the routine 300 terminates at block 306.

If a successful response is not received at decision block 304, a test is conducted to determine whether to begin radio communication priming at decision block 308. In an illustrative embodiment, an unsuccessful response to an application-layer request can include an error report that identifies a potential cause of the unsuccessful request. In the event that an error can be identified as relating to radio communication unavailability, there may be a need to prime the radio and network layer components 104. If radio communication priming is not to begin, the routine 300 terminates at block 306. If radio communication priming is to begin, at block 310, the mobile device 102 obtains radio communication priming configuration parameters. In an illustrative embodiment, the radio communication priming configuration parameters can include a specification as to the number of successive HTTP GET requests to attempt and a retry threshold between each successive request.

At block 312, the communications management component instructs the radio and network layer components 104 to transmit a communication corresponding to a network-level communication protocol. In an illustrative embodiment, the series of network-level communications can correspond to TCP Connect or DNS commands that transmit a data packet from the mobile device 102 to a network computing device 110. In an illustrative embodiment, the successive data packet transmission will mitigate the likelihood that the radio communication and network components will be unavailable during routine 300. In an illustrative embodiment, in the event that the radio and network layer components 104 do receive a positive response to the network-level communication, a communication can be resent. The radio and network layer components 104 include an exponential delay between successive network-level communications.

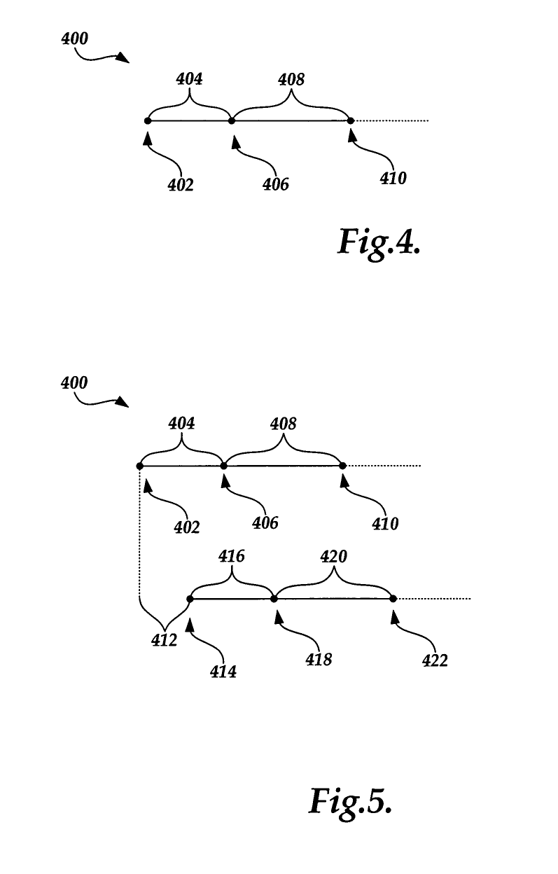

FIG. 4 is a communication diagram 400 corresponding to a first set of communications from a mobile device 102. As illustrated in FIG. 4, at point 402, the mobile device 102 transmits the application-level information request. Upon receipt of an unsuccessful application-level communication request, the mobile device 102 transmits a network-level communication request at point 406. If an answer response to the information request is still not received upon the expiration of a second interval 408, the mobile device 102 would be prepared to transmit another network-level data packet at point 410. As illustrated in FIG. 4, the second time interval 408 may be longer in duration that the first time interval 404.

Returning to FIG. 3, at decision block 314, a test is conducted to determine whether a successful response to the network-level communication has been received. If a successful communication has been received, the routine 300 returns to block 302 to transmit another application-level communication request. If a successful response to the network-level communication has not been received, at decision block 316, a test is conducted to determine whether a retry time threshold for transmitting another information requests has expired. As described above, in an illustrative embodiment, the radio communication priming configuration parameters include a threshold for specifying an interval for sending a successive application-level information request. If the retry time threshold has not expired, at block 318, the mobile device 102 enters into a delay cycle until the retry time threshold has expired. If the retry interval has expired or upon expiration of the retry interval in the delay cycle, at decision block 320, a test is conducted to determine whether a number of application-layer information request retries has expired. As also specified above, the radio communication priming configuration parameters can also include a number of application-level requests that will be retried. If the number of retries has been exceeded, the routine 300 terminates at block 306. Alternatively, the routine 300 returns to block 302 to transmit a successive application-level request.

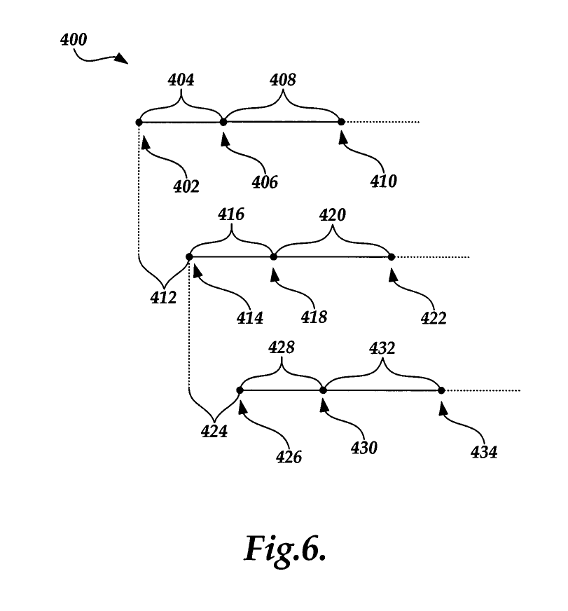

With reference now to FIGS. 5 and 6, communication diagrams for successive application-level and network-level communications will be described. With reference to FIG. 5, in addition to the communication thread illustrated with regard to points 402, 406, 410, upon expiration of a retry time threshold 412, the mobile device begins a second communication thread. Similar to the first communication thread, at point 414, the mobile device 102 transmits a second application-level information request. Upon receipt of an unsuccessful application-level communication request, the mobile device 102 transmits the network-level communication request at point 418. If an answer response to the information request is still not received upon the expiration of a second interval 420, the mobile device 102 would be prepared to transmit another network-level data packet at point 422. As illustrated in FIG. 5, the repetitive network-level communication request of the first communication thread can continue in conjunction with the processing of the second communication thread.

With reference now to FIG. 6, in addition to the communication threads illustrated with regard to points 402, 406, 410 and 414, 418, 122, upon expiration of a retry time threshold 424, the mobile device begins a third communication thread. In an illustrative embodiment, retry thresholds 412 and 424 may be substantially similar or identical. Alternatively, the retry threshold 412, 424 may be progressively increased to delay additional application-level data requests. With reference to FIG. 6, similar to the first and second communication threads, at point 426, the mobile device 102 transmits a third application-level information request. Upon receipt of an unsuccessful application-level communication request, the mobile device 102 transmits the network-level communication request at point 430. If an answer response to the information request is still not received upon the expiration of a second interval 432, the mobile device 102 would be prepared to transmit another network-level data packet at point 434. In a manner similar to FIG. 5, the repetitive network-level communication request of the first and second communication thread can continue in conjunction with the processing of the third communication thread.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. A method for managing radio frequency communications in a mobile device, the method comprising:
transmitting a first data request using an application-level communication protocol;
transmitting at least one data packet using a network-level communication protocol upon receipt of an unsuccessful response to the first data request;
if a time threshold has been exceeded prior to receiving a response corresponding to the first data request, transmitting a second data request using the application-level communication protocol; and
transmitting at least one data packet using the network-level communication protocol upon receipt of an unsuccessful response to the second data request.

2. The method as recited in claim 1, wherein transmitting the first and second data request corresponds to an information request utilizing a hypertext transfer protocol command.

3. The method as recited in claim 1, wherein transmitting at least one data packet using a network-level communication protocol corresponds to a connection request utilizing a transmission control protocol.

4. The method as recited in claim 1, wherein transmitting at least one data packet using a network-level communication protocol corresponds to a domain name service request utilizing a transmission control protocol.

5. The method as recited in claim 1, wherein transmitting at least one data packet using a network-level communication protocol includes transmitting a series of data packets using the network-level communication protocol prior to receiving a response corresponding to the first data request.

6. The method as recited in claim 5, wherein transmitting a series of data packets using the network-level communication protocol prior to receiving a response includes:
transmitting a first data packet using the network-level communication protocol;
determining that a threshold amount of time has expired; and
transmitting a second data packet using the network-level communication protocol.

7. The method as recited in claim 1 further comprising:
if a second time threshold has been exceeded prior to receiving a response corresponding to the second data request, transmitting a third data request using the application-level communication protocol; and
transmitting at least one data packet using the network-level communication protocol upon receipt of an unsuccessful response to the third data request.

8. The method as recited in claim 7, wherein the second time threshold and the time threshold has been exceeded prior to receiving a response corresponding to the first data request are substantially similar.

9. The method as recited in claim 1, wherein the time threshold has been exceeded prior to receiving a response corresponding to the first data request is exponentially smaller than the second time threshold.

10. A method for managing radio frequency communications in a mobile device, the method comprising:
transmitting a first communication using a first communication protocol;
transmitting at least one data packet using a second communication protocol prior to upon receipt of an unsuccessful response to the first communication;
if a first time threshold has been exceeded prior to receiving a response corresponding to the first communication, transmitting a second communication using the first communication protocol; and
transmitting at least one data packet using the second communication protocol upon receipt of an unsuccessful response to the second communication.

11. The method as recited in claim 10, wherein transmitting at least one data packet using the second communication protocol includes transmitting a series of data packets using the second communication protocol.

12. The method as recited in claim 11, wherein transmitting a series of data packets using the second communication protocol prior to receiving a response includes:
transmitting a first data packet using the second communication protocol;
determining that a threshold amount of time has expired; and
transmitting a second data packet using the second communication protocol.

13. The method as recited in claim 10, wherein the first communication protocol is an application-level communication protocol.

14. The method as recited in claim 10, wherein the second communication protocol is a network-level communication protocol.

15. The method as recited in claim 10 further comprising:
if a second time threshold has been exceeded prior to receiving a response corresponding to the second communication, transmitting a third communication using the first communication protocol; and
transmitting at least one data packet using the second communication protocol upon receipt of an unsuccessful response to the third communication.

16. A computer-readable medium having computer-executable components for managing communications in a radio device, the computer-executable components comprising:
a network layer and radio layer communication component for transmitting and receiving data; and
a communications management component for transmitting an instruction to the network layer and radio layer communication component to elicit an action. .

17. The computer-readable components as recited in claim 16, wherein the communications management component instructs the network layer and radio layer communication component to toggle a power mode.

18. The computer-readable components as recited in claim 16, wherein the communications management component instructs the network layer and radio layer communication component to begin a voice connection for maintaining radio availability.

19. The computer-readable components as recited in claim 16, wherein the communications management component instructs the network layer and radio layer communication component to transmit a data instruction.

20. The computer-readable components as recited in claim 19, wherein the data instruction corresponds to an application layer-protocol.
